(19) United States
(12) Patent Application Publication
(10) Pub. No.: US 2025/0097069 A1
(43) Pub. Date: Mar. 20, 2025

(54) ELECTRONIC CONTROL DEVICE, CONTROL SYSTEM, CONTROL METHOD, AND COMPUTER PROGRAM PRODUCT

(71) Applicant: DENSO CORPORATION, Kariya-city (JP)

(72) Inventor: YASUHIRO KOTANI, Kariya-city (JP)

(21) Appl. No.: 18/826,897

(22) Filed: Sep. 6, 2024

(30) Foreign Application Priority Data
Sep. 20, 2023 (JP) 2023-152100

(51) Int. Cl. H04L 12/40; H04L 12/12

(52) U.S. Cl. CPC H04L 12/40039; H04L 12/12; H04L 2012/40273

(57) ABSTRACT

An electronic control device, which is mounted on a vehicle, includes at least one transceiver performing a communication with a communication device and a controller switching between two of multiple modes including a first mode, a second mode, and a third mode. The controller operates in the first mode to perform a process associated with the communication in a case where the communication is being performed, switches to the second mode in a case where no communication is performed in the first mode, switches to the third mode in a case where no communication is performed in the second mode for a predetermined period of time and partially stops the process associated with the communication. The at least one transceiver switches to a sleep state in a case where the at least one transceiver detects a communication disabled state in the third mode of the controller.

### CROSS REFERENCE TO RELATED APPLICATION

The present application claims the benefit of priority from Japanese Patent Application No. 2023-152100 filed on Sep. 20, 2023. The entire disclosure of the above application is incorporated herein by reference.

### TECHNICAL FIELD

The present disclosure relates to an electronic control device, a control system, a control method, and a computer program product.

### BACKGROUND

Vehicles are equipped with a large number of electronic control devices to control vehicle-mounted devices. The electronic control devices are also referred to as electronic control units (ECUs). By connecting the multiple ECUs to a communication bus, a network system including the ECUs as communication nodes is constructed.

### SUMMARY

An electronic control device, which is mounted on a vehicle, includes at least one transceiver performing a communication with a communication device and a controller switching between two of multiple modes including a first mode, a second mode, and a third mode. The controller operates in the first mode to perform a process associated with the communication in a case where the communication is being performed, switches to the second mode in a case where no communication is performed in the first mode, switches to the third mode in a case where no communication is performed in the second mode for a predetermined period of time and partially stops the process associated with the communication. The at least one transceiver switches to a sleep state in a case where the at least one transceiver detects a communication disabled state in the third mode of the controller.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a configuration of a control system;

FIG. 2 is a flowchart of a process executed by a transceiver to detect a link- down state;

FIG. 3 is a state switch diagram illustrating a state switch among operation modes of a controller;

FIG. 4 is a diagram illustrating switches of operation modes of a controller and states of a transceiver in a first embodiment;

FIG. 5 is a flowchart of a process executed by controller to switch from a sleep mode to a network mode in the first embodiment;

FIG. 6 is a flowchart of a process executed by a controller of an ECU having a master transceiver when the controller switches from a prepared bus sleep mode through a bus sleep mode to a sleep mode in the first embodiment;

FIG. 7 is a flowchart of a process executed by a controller of an ECU having a slave transceiver when the controller switches from a prepared bus sleep mode through a bus sleep mode to a sleep mode in the first embodiment;

FIG. 8 is a diagram illustrating switches of operation modes of a controller and states of a transceiver in a second embodiment;

FIG. 9 is a flowchart of a process executed by a controller of an ECU having a master transceiver when the controller switches from a prepared bus sleep mode through a bus sleep mode to a sleep mode in the second embodiment;

FIG. 10 is a diagram illustrating switches of operation modes of a controller and states of a transceiver in a case where a handshake initiated by a second ECU is succeeded in a third embodiment;

FIG. 11 is a diagram illustrating switches of operation modes of a controller and states of a transceiver in a case where the handshake initiated by the second ECU is failed in the third embodiment;

FIG. 12 is a flowchart of a process executed by a controller of an ECU having a slave transceiver when the controller switches from a prepared bus sleep mode through a bus sleep mode to a sleep mode in the third embodiment;

FIG. 13 is a flowchart of a process executed by an ECU including a slave transceiver when the slave transceiver switches from a normal state to a sleep state in the third embodiment;

FIG. 14 is a diagram illustrating switches of operation modes of a controller and states of a transceiver in a case where a handshake initiated by a first ECU is failed in the third embodiment;

FIG. 15 is a flowchart of a process executed by a controller of an ECU having a master transceiver when the controller switches from a prepared bus sleep mode through a bus sleep mode to a sleep mode in the third embodiment; and

FIG. 16 is a flowchart of a process executed by an ECU including a master transceiver when the master transceiver switches from a normal state to a sleep state in the third embodiment.

### DETAILED DESCRIPTION

In a network system in which multiple ECUs are connected to a communication bus, when no data packet is output to the network for a certain period of time, an operation mode of each ECU switches from a normal mode to a power-saving mode. In the normal mode, various functions are in operation states. In the power-saving mode, some functions, which were operated in the normal mode, are stopped to reduce power consumption. Thus, in the power-saving mode, power consumption can be reduced by stopping some functions.

According to a related art, a network system enables low power consumption by configuring a partial network based on a communication control of controller area network (CAN, registered trademark) protocol standard defined in ISO 11898-6. This network system reduces the power consumption by separately activating or deactivating nodes, which configure the network.

Each ECU includes a transceiver as a communication interface for communicating with another ECU. The transceiver includes a master transceiver and a slave transceiver.

The master transceiver of each ECU periodically transmits a detection signal to the slave transceiver of another ECU. When the slave transceiver of each ECU receives the detection signal transmitted from a master transceiver of another ECU, the slave transceiver transmits a response signal to the detection signal transmitted from the master transceiver of another ECU, which corresponds to the transmission source of detection signal. By receiving, from another ECU, the response signal to the detection signal, the master transceiver of transmission source ECU can confirm that the slave transceiver that transmitted the response signal is in a communication-enabled state with the transmission source ECU of detection signal. By periodically receiving the detection signal, the slave transceiver can confirm that the master transceiver of the transmission source of the detection signal is in a communication-enabled state with the slave transceiver. With this process, when each ECU confirms that another ECU is in a communication-enabled state with own ECU, each ECU can perform communication with another ECU.

When a condition for switching an operation mode from the normal mode to the power-saving mode is satisfied, each ECU starts a process for switching to the power-saving mode. At this time, an ECU equipped with the slave transceiver may receive the detection signal transmitted from the master transceiver of another ECU, and reception of the detection signal prevents the ECU from switching to the power-saving mode.

According to an aspect of the present disclosure, an electronic control device, which is mounted on a vehicle, includes: at least one transceiver configured to perform a communication with a communication device; and a controller configured to switch between two of multiple modes including a first mode, a second mode, and a third mode, thereby operating in one of the multiple modes. The controller: operates in the first mode to perform a process associated with the communication in a case where the communication is being performed with the communication device by the at least one transceiver; switches to the second mode in a case where no communication is performed in the first mode; switches to the third mode in a case where a state in which no communication is performed in the second mode continues for a predetermined period of time; and stops at least a part of the process associated with the communication in the third mode. The at least one transceiver: switches between two of multiple states including a normal state in which a predetermined function of the at least one transceiver is in an operation state and a sleep state in which the predetermined function of the at least one transceiver is in a stopped state, thereby operating in one of the multiple states; and switches to the sleep state in a case where the at least one transceiver detects a communication disabled state, in which the communication with the communication device is disabled, in a state where the controller is operating in the third mode.

With the above configuration, it is possible to suppress, for the transceiver of electronic control device, the obstruction of mode switch from the normal mode to the sleep mode. The obstruction of mode switch from the normal mode to the sleep mode is caused by reception of the detection signal. Thus, in the electronic control device that has a mode of stopping partial operations as the power-saving mode, the obstruction of mode switch to the power-saving mode when the obstruction of mode switch is caused by reception of the detection signal from another communication device.

According to another aspect of the present disclosure, an electronic control device, which is mounted on a vehicle, includes at least one transceiver configured to perform a communication with a communication device; and a controller configured to switch between two of multiple modes including a first mode, a second mode, and a third mode, thereby operating in one of the multiple modes. The controller: operates in the first mode to perform a process associated with the communication in a case where the communication is being performed with the communication device by the at least one transceiver; switches to the second mode in a case where no communication is performed in the first mode; switches to the third mode in a case where a state in which no communication is performed in the second mode continues for a predetermined period of time; and stops at least a part of the process associated with the communication in the third mode. The at least one transceiver: switches between two of multiple states including a normal state in which a predetermined function of the at least one transceiver is in an operation state and a sleep state in which the predetermined function of the at least one transceiver is in a stopped state, thereby operating in one of the multiple states; repeatedly transmits, in the normal state, a detection signal to the communication device for detecting whether the communication device is in a communication disabled state in which the communication is disabled; and stops transmission of the detection signal and then switches to the sleep state in a case where the controller is operating in the third mode.

With the above configuration, it is possible to suppress, for the transceiver of electronic control device, the obstruction of mode switch from the normal mode to the sleep mode. The obstruction of mode switch from the normal mode to the sleep mode is caused by reception of the detection signal. Thus, in the electronic control device that has a mode of stopping partial operations as the power-saving mode, the obstruction of mode switch to the power-saving mode when the obstruction of mode switch is caused by reception of the detection signal from another communication device.

The following will describe exemplary embodiments of the present disclosure with reference to the drawings.

### 1. First Embodiment

### 1-1. Configuration

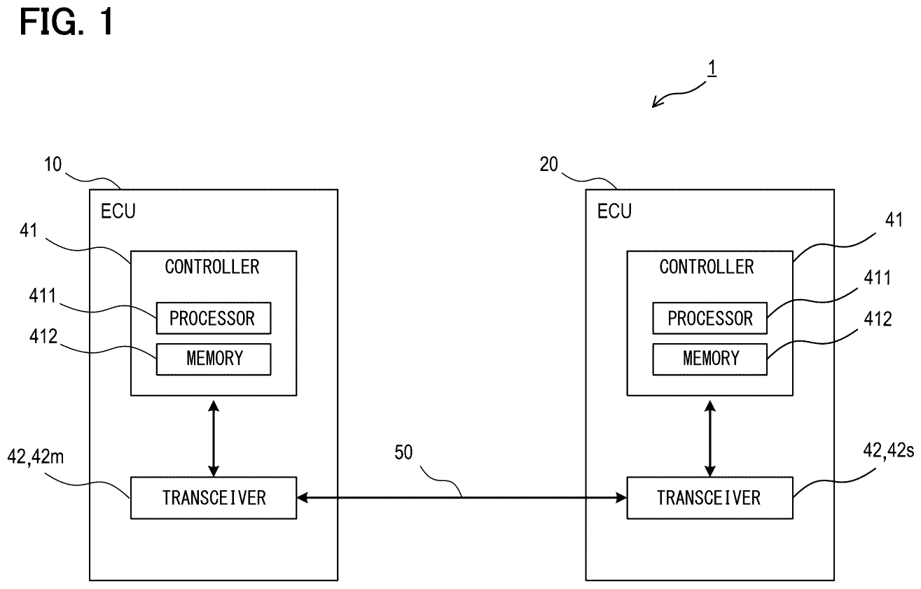

A control system 1 according to the present embodiment is shown in FIG. 1, and the control system 1 is mounted on a vehicle. The control system 1 includes a first ECU 10 and a second ECU 20. The first ECU 10 and the second ECU 20 are connected to the same in-vehicle network. Each of the first ECU 10 and the second ECU 20 may be an ECU that processes information obtained from sensors, such as cameras and radars, for autonomous driving purpose, an ECU that processes information to be output to a display device, such as a vehicle display or a meter, or an ECU that communicates with an external terminal.

The first ECU 10 and the second ECU 20 each includes a controller 41 and at least one transceiver 42.

The controller 41 is a microcontroller having a processor 411 and a memory 412. The processor 411 is configured to execute processing in accordance with a computer program stored in the memory 412. The memory 412 may include, for example, RAM and flash memory. The RAM is used as a working area when the processor 411 executes the processing. The flash memory is capable of storing computer programs.

The transceiver 42 is a communication interface capable of communicating with another transceiver 42 through an in-vehicle network using a predetermined communication protocol. The communication mentioned here includes transmissions and receptions of various signals, data, and the like. The predetermined communication protocol may be, for example, an Ethernet protocol. The communication protocol is not limited to Ethernet, and may adopt CAN or FlexRay. Ethernet is a registered trademark. CAN is a registered trademark. FlexRay is a registered trademark.

The transceiver 42 is classified into a master transceiver 42m and a slave transceiver 42s. The master transceiver 42m performs one-to-one communication with the slave transceiver 42s. The slave transceiver 42s performs one-to-one communication with the master transceiver 42m. In other words, no communication is performed between two master transceivers 42m. Similarly, no communication is performed between two slave transceivers 42s.

In the present embodiment, the transceiver 42 mounted on the first ECU 10 is the master transceiver 42m. The transceiver 42 mounted on the second ECU 20 is the slave transceiver 42s.

The master transceiver 42m transmits an idle signal to the slave transceiver 42s at regular intervals (for example, every several hundred nanoseconds to several thousand nanoseconds). The idle signal is a detection signal for detecting whether an ECU to which the idle signal is transmitted is capable of performing a communication. Upon receiving the idle signal, the slave transceiver 42s transmits, to the master transceiver 42m, a response signal as a response to the idle signal.

By receiving the response signal, the master transceiver 42m detects that the ECU including the slave transceiver 42s to which the idle signal was transmitted is in a link-up state in which communication is enabled. In a case where the master transceiver 42m fails to receive the response signal within a predetermined period (e.g., a few seconds), the mater transceiver detects that the ECU equipped with the slave transceiver 42s to which the idle signal was transmitted is in a link-down state in which communication cannot be performed. The link-down state corresponds to a state in which the communication is disabled.

By receiving the idle signal, the slave transceiver 42s detects that the ECU including the master transceiver 42m, which corresponds to a transmission source of the idle signal, is in the link-up state. In the link-up state, the communication is enabled. In a case where the slave transceiver 42s fails to receive the idle signal within a predetermined period (e.g., a few seconds), the slave transceiver detects that the ECU equipped with the master transceiver 42m, which transmitted the idle signal, is in the link-down state. In the link-down state, the communication is disabled.

When the master transceiver 42m detects that the ECU that transmitted the response signal is in the link-down state, the master transceiver notifies the controller 41 of corresponding ECU to which the master transceiver belongs (hereinafter referred to as local ECU) about detection of the link-down state. When the slave transceiver 42s detects that the ECU that transmitted the idle signal is in the link-down state, the slave transceiver notifies the controller 41 of corresponding ECU to which the slave transceiver belongs (hereinafter referred to as local ECU) about detection of the link-down state. Hereinafter, the notification of detection of link-down state is referred to as a link-down notification.

The first ECU 10 and the second ECU 20 are connected with one another through a link 50 serving as a transmission path in the in-vehicle network. The first ECU 10 is capable of communicating with the second ECU 20 via the master transceiver 42m of the first ECU 10 and the link 50. The second ECU 20 is capable of communicating with the first ECU 10 via the slave transceiver 42s of the second ECU 20 and the link 50.

### 1-2. Process

### (1-2-1. Operation States and Functions of Transceiver)

The transceiver 42 operates in an operation state, which is one of multiple operation states. The multiple operation states include a normal state and a sleep state. The transceiver 42 switches between the normal state and the sleep state according to a predetermined protocol. One example of the predetermined protocol is TC10 (Technical Committee 10) defined by the non-profit organization OPEN Alliance (One-Pair Ether-Net Alliance). The transceiver 42 has a sleep function and a wake-up function.

The normal state is a state in which the transceiver 42 is capable of communicating with other transceivers 42.

The sleep state is a state in which a predetermined function of the transceiver 42, which is operable in the normal state, is stopped. An example of the predetermined function of the transceiver 42 is a function of transmitting various signals, data, and the like to another transceiver 42. The sleep state is a state in which power to operate the predetermined function, which is in stopped state, is not supplied. Thus, the sleep state corresponds to a power-saving state in which power consumption is reduced compared to the normal state. The transceiver 42 becomes the sleep state when an ignition switch of the vehicle is turned from OFF state to ON state.

The master transceiver 42m in the sleep state does not transmit the idle signal. The slave transceiver 42s in the sleep state does not transmit the response signal as a response to the idle signal. In a case where at least one of the master transceiver 42m or the slave transceiver 42s is in the sleep state, both the first ECU 10 and the second ECU 20 are in the link-down state. In a case where both the master transceiver 42m and the slave transceiver 42s are in the normal state, the first ECU 10 and the second ECU 20 are in the link-up states.

The sleep function is executed in a case where a request is transmitted from the controller 41 of local ECU. By executing the sleep function, processing for stopping the predetermined function of transceiver 42 is performed. The sleep function is a function for the transceiver 42 to switch from the normal state to the sleep state upon the request from the controller 41.

The wake-up function is a function to perform processing to restart the predetermined function of transceiver 42 that has been stopped by the sleep function. The wake-up function is a function for the transceiver 42 to switch from the sleep state to the normal state.

The wake-up function is executed in a case where the transceiver 42 receives a wake-up request. The wake-up request is a signal that requests the controller 41 to switch to a network mode A101, which will be described later.

The wake-up requests received by the transceiver 42 include a wake-up request transmitted from another ECU (hereinafter referred to as an adjacent ECU) that is an adjacent node in the in-vehicle network, and also includes a wake-up request transmitted from the controller 41 of local ECU to the adjacent ECU. In a case where the transceiver 42 receives the wake-up request from the adjacent ECU, the transceiver 42 notifies the controller 41 of local ECU about reception of the wake-up request. In a case where the transceiver 42 receives the wake-up request transmitted from the controller 41 of local ECU to the adjacent ECU, the transceiver 42 transmits the wake-up request to the adjacent ECU.

After completing the processing to restart the predetermined function of the transceiver 42, which was stopped by the sleep function, the transceiver 42 switches from the sleep state to the normal state.

### (1-2-2. Detection of Link-Down State by Transceiver)

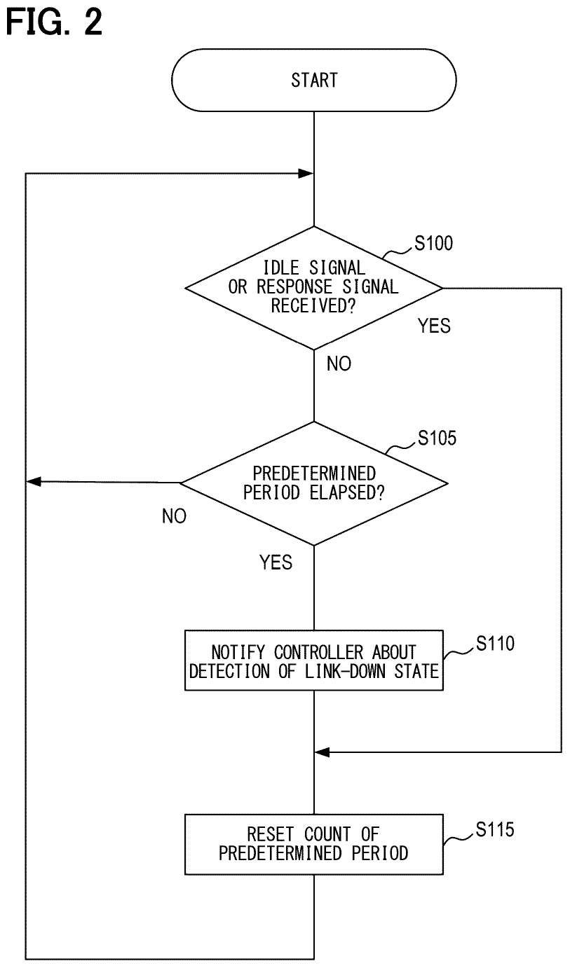

The process in which the transceiver 42, which is the master transceiver 42m or the slave transceiver 42s, detects the link-down state will be described with reference to the flowchart of FIG. 2.

In response to switching to the normal state, the transceiver 42 starts the process shown in FIG. 2.

First, in S100, the transceiver 42 determines whether an idle signal or a response signal is received.

In a case where the transceiver 42 determines in S100 that an idle signal or a response signal is received (S100: YES), the transceiver 42 proceeds to S115 to reset a counter of a predetermined period, and returns to S100.

In a case where the transceiver 42 determines in S100 that no idle signal or no response signal is received (S100: NO), the transceiver 42 proceeds to S105, and determines whether the predetermined period has elapsed.

In a case where the transceiver 42 determines in S105 that the predetermined period has not elapsed (S105: NO), the process returns to S100.

In a case where the transceiver 42 determines in S105 that the predetermined period has elapsed (S105: YES), the process proceeds to S110. In S110, the transceiver 42 notifies the controller 41 that the ECU that transmitted the idle signal or the response signal is in a link-down state.

In S115, the counter of predetermined period is reset, and the process returns to S100.

In this way, in a case where the transceiver 42 fails to receive the idle signal or the response signal within the predetermined period, the transceiver 42 detects that another ECU equipped with the transceiver 42 that transmitted the idle signal or the response signal to the local ECU is in a link-down state in which communication is disabled, and transmits a link-down notification indicating that another ECU is in the link-down state, to the own controller 41.

### (1-2-3. Operation Modes of Controller)

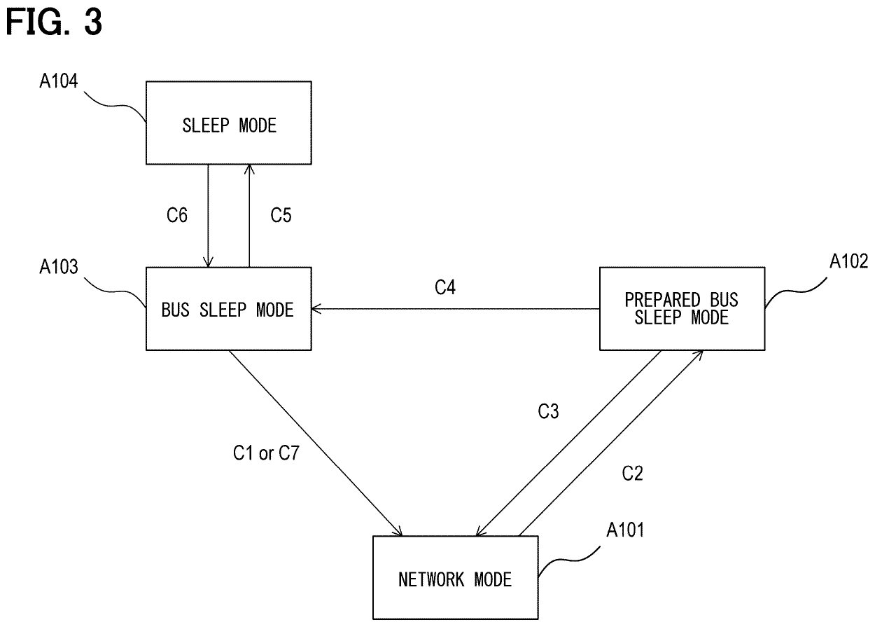

As shown in FIG. 3, the controller 41 has, as operation modes, a network mode A101, a prepared bus sleep mode A102, a bus sleep mode A103, and a sleep mode A104. The controller 41 switches among the network mode A101, the prepared bus sleep mode A102, the bus sleep mode A103, and the sleep mode A104, in accordance with a predetermined protocol. One example of the predetermined protocol is UdpNm (UDP Network Management) defined by AUTOSAR (AUTomotive Open System ARchitecture), which is a global development partnership in the automotive industry.

The network mode A101 is an operation mode in which the controller 41 communicates with the adjacent ECU through the transceiver 42. The controller 41 in the network mode A101 executes processing related to a communication with the adjacent ECU. Examples of the processing related to the communication include processing for generating various signals, data, and the like to be transmitted toward the adjacent ECUs and transmitting the generated signals or data toward the transceiver 42, and processing for acquiring various signals, data, and the like transmitted from the adjacent ECU using the transceiver 42 of local ECU. The network mode A101 is maintained until a predetermined period has elapsed since the communication with the adjacent ECU is stopped. The predetermined period may be set within a range of several milliseconds to several thousand milliseconds.

The prepared bus sleep mode A102 is an operation mode in which the ECU waits for elapse of a predetermined period in a state where no communication is performed between the local ECU and the adjacent ECU. The predetermined period may be set within a range of several milliseconds to several thousand milliseconds. The predetermined period in the prepared bus sleep mode may be different from the predetermined period in the network mode A101. The network mode A101 and the prepared bus sleep mode A102 are included in normal mode in which various functions of the ECU are in operation states.

In a case where the bus sleep mode A103 is switched from the prepared bus sleep mode A102, processing required to stop some of the functions, which were in operation states in the network mode A101, are stopped in the bus sleep mode A103. Examples of the functions to be stopped include generations of various signals, data, and the like to be transmitted to the adjacent ECU and transmitting the various signals, data, and the like, to the transceiver 42. Examples of processing required to stop some of the functions include processing to disable setting values of the controller 41 relating to transmission of signals or data to the transceiver 42, and processing to stop operating purpose clock, timer, and the like used in the function to be stopped.

In a case where the bus sleep mode A103 is switched from the sleep mode A104 or the bus sleep mode A103 is activated in response to power supply to the controller 41, processing required to start operation to be performed in the network mode A101 is executed in the bus sleep mode A103. Examples of the processing required to start operation include processing to enable the setting values of controller 41 relating to transmission of signals or data to the transceiver 42, and processing to start operating purpose clock, timer, and the like used in generation of various signals or data to be transmitted to the adjacent ECU, and processing to transmit the generated signals or data to the transceiver 42. In this case, the processing performed by the controller 41 in the bus sleep mode A103 includes restarting functions that have been stopped in response to switch from the prepared bus sleep mode A102 to the bus sleep mode A103. The controller 41 transmits the wake-up request to the adjacent ECU. As a result, the controller 41 of adjacent ECU switches to the network mode A101 in which communication is enabled.

The sleep mode A104 is an operation mode in which some of the functions, which were in operation states in the network mode A101, are stopped. Alternatively, the sleep mode A104 is a state in which power is not supplied to the controller 41. The functions stopped in the sleep mode A104 correspond to the functions for which processing required for stopping the functions have been performed in the bus sleep mode A103. The sleep mode A 104 is a power-saving mode in which some functions are stopped to reduce power consumption, compared to the normal mode.

### (1-2-4. Switch of Operation Mode of Controller)

The switch of operation mode of the controller 41 will be described with reference to FIG. 3.

When the ignition switch of the vehicle is turned on, the controller 41 enters the bus sleep mode A103 as an initial mode. Alternatively, the initial mode may be set to sleep mode A104. In this case, the controller 41 may be configured to switch from the sleep mode A104 to the bus sleep mode A103 after the vehicle ignition switch is turned from off state to on state.

In the bus sleep mode A103, the controller 41 executes processing required to start operation to be performed in the network mode A101. An example of such a processing is described above. After the processing in the bus sleep mode is completed, the controller 41 determines that a switch condition C1 is satisfied and switches to the network mode A101. The switch condition C1 is satisfied when the processing required to start operation to be performed in the network mode A101 is completed.

In a case where the controller 41 determines that a switch condition C2 is satisfied in the network mode A101, the controller 41 switches to the prepared bus sleep mode A102. The switch condition C2 is satisfied in a case where a predetermined period (for example, several milliseconds to several thousand milliseconds) is elapsed without detecting communication between the local ECU and the adjacent ECU. In addition, the switch condition C2 may include that the ECU receives information or an instruction, which indicates a switch to the prepared bus sleep mode A102, from the adjacent ECU.

In a case where the controller 41 determines that a switch condition C3 is satisfied in the prepared bus sleep mode A102, the controller 41 switches to the network mode A101. The switch condition C3 is satisfied in a case where a communication between local ECU and the adjacent ECU is detected. When a specific communication, which is specified in advance, occurs as the communication in the prepared bus sleep mode A102 between local ECU and the adjacent ECU, the controller 41 does not switch to the network mode A101. That is, the switch condition C3 is a condition that a communication other than the specific communication occurs between local ECU and the adjacent ECU. In the present embodiment, the specific communication is defined as a transmission or reception of the idle signal or the response signal.

In a case where the controller 41 determines that a switch condition C4 is satisfied in the prepared bus sleep mode A102, the controller 41 switches to the bus sleep mode A103. The switch condition C4 is satisfied in a case where a predetermined period (for example, several milliseconds to several thousand milliseconds) is elapsed in a state where no communication other than the specific communication is occurred between local ECU and the adjacent ECU. The predetermined period set in the switch condition C4 may be different from the predetermined period set in the switch condition C2, or the predetermined period may not be set in the switch condition C4. That is, the predetermined period in the switch condition C4 may be set to 0 second. Counting of the predetermined period in the switch condition C4 may be started at the time in a case where the controller 41 switches to the prepared bus sleep mode A102 or at the last detection of communication in the network mode A101. When counting of the predetermined period in the switch condition C4 starts at the last detection of communication in the network mode A101, the predetermined period in the switch condition C4 becomes equal to or longer than the predetermined period in the switch condition C2.

When the controller 41 determines that a switch condition C5 is satisfied in the bus sleep mode A103, the controller 41 switches to the sleep mode A104. The switch condition C5 is satisfied in a case where a processing required for stopping partial functions, which were in operation states in the network mode A101, is completed. An example of such a processing is described above. The switch condition C5 includes a condition that a predetermined function of the transceiver 42 is stopped by the sleep function. Examples of the predetermined function that is stopped by the sleep function may include transmission of various signals, data, or the like, to another transceivers 42.

When the controller 41 determines a switch condition C6 is satisfied in the sleep mode A104, the controller 41 switches to the bus sleep mode A103. The switch condition C6 is satisfied in a case where a factor causing a return from the power-saving mode to the normal mode (hereinafter, referred to as a returning factor) is occurred. The returning factor also includes receiving of a wake-up request from the adjacent ECU. The returning factor may be set to be different for each ECU. Examples of the returning factor include unlock of a vehicle door, reception of a predetermined signal (for example, an operation signal for operating a vehicle equipment, such as an engine or an air conditioning device) transmitted from outside of the vehicle by a telematics control unit (TCU) mounted on the vehicle.

When the controller 41 determines that a switch condition C7 is satisfied in the bus sleep mode A103, the controller 41 switches to the network mode A101. The switch condition C7 is satisfied in a case where a process required for switching to the network mode A101 corresponding to the returning factor is completed. The processing required for the mode switch corresponds to the processing required for starting operation in the network mode A101 as described above. The switch condition C7 includes a condition that a predetermined function of the transceiver 42 is restarted by the wake-up function. The predetermined function to be restarted is the predetermined function that was stopped by the sleep function described above.

### (1-2-5. Switch Between Power-Saving Mode and Normal Mode Within Control System)

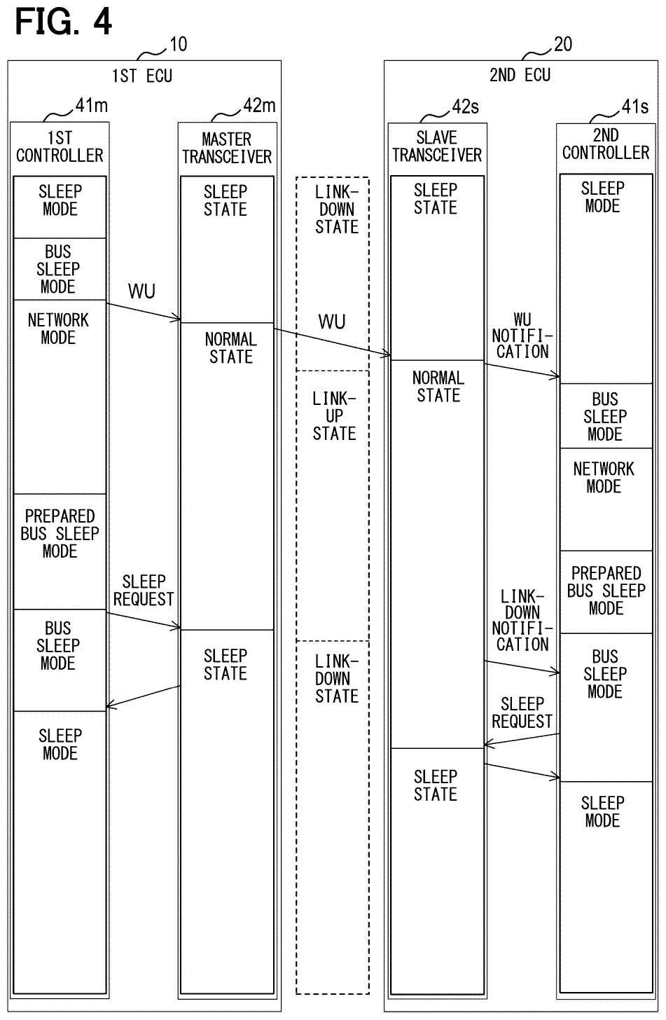

In the control system 1, the operation modes and state switch of the controller 41 and transceiver 42 of each ECU in a case of switching from the power-saving mode to the normal mode and in a case of switching from the normal mode to the power-saving mode will be described with reference to FIG. 4 to FIG. 7.

### (1-2-5-1. SwitchFfrom Power-Saving Mode to Normal Mode)

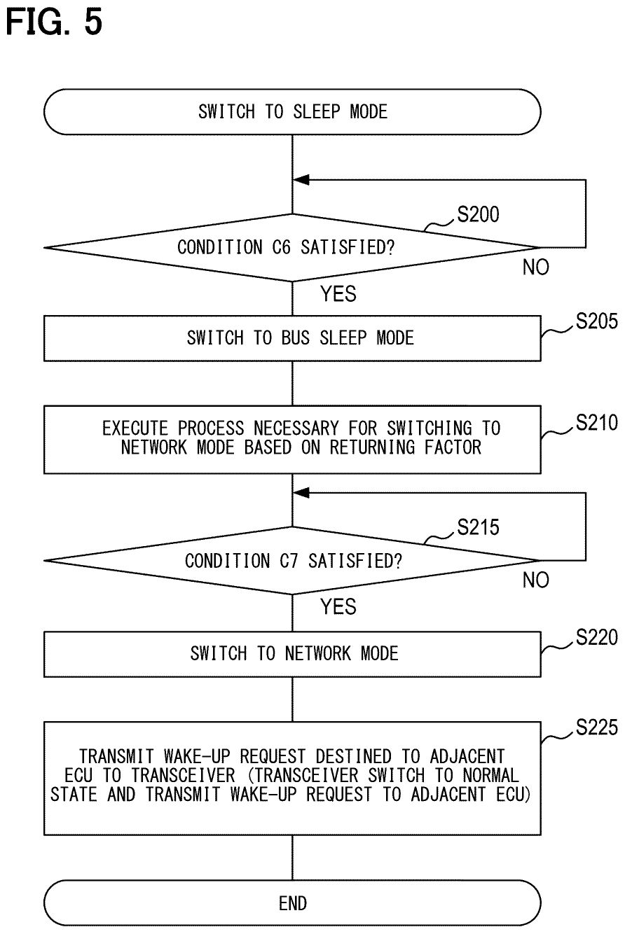

The operation mode of controller 41 and the state switch of the transceiver 42 of each ECU in a case of switching from the power-saving mode to the normal mode will be described with reference to the flowcharts shown in FIG. 4 and FIG. 5.

In the following description, a first controller 41m corresponds to the controller 41 included in the first ECU 10. A second controller 41s corresponds to the controller 41 included in the second ECU 20.

Suppose that both of the first ECU 10 and the second ECU 20 in the control system 1 operate in the power-saving modes. At this time, the controller 41m, 41s of each ECU is in the sleep mode A104, and the transceiver 42m, 42s of each ECU is in the sleep state. That is, both the first ECU 10 and the second ECU 20 are in the link-down states.

In a case where a returning factor occurs, out of the first ECU 10 and the second ECU 20, a predetermined ECU corresponding to the returning factor switches to the bus sleep mode A103. Then, the predetermined ECU corresponding to the returning factor starts the processing required to start operation to be performed in the network mode A101. In a case where the ignition switch is switched from off state to on state, the predetermined ECU switches to the bus sleep mode A103. In the following, an example will be described in which the first ECU 10 switches from the sleep mode A104 to the network mode A101 via the bus sleep mode A103, as the predetermined ECU corresponding to the returning factor. The same applies to the case where the ignition switch is turned from off state to on state and the first ECU 10 switches to the bus sleep mode A103.

When the first controller 41m switches to the sleep mode A104, the first controller 41m starts the process shown in FIG. 5.

The first controller 41m repeats the process in S200 until the switch condition C6 is satisfied (S200: NO). The switch condition C6 is satisfied in response to occurrence of the returning factor.

In a case where the first controller 41m determines in S200 that the switch condition C6 is satisfied (S200: YES), the process proceeds to S205, and the first controller 41m switches to the bus sleep mode A103.

In S210, the first controller 41m executes processing required to switch to the network mode A101 based on the returning factor. An example of the processing includes validating a setting value related to a transmission of signal or data to the master transceiver 42m, among the setting values of the first controller 41m. Examples of the processing further include starting of operating clock, timer, etc. used for generation of various signals, data, etc. to be transmitted to the second ECU 20, which corresponds to the adjacent ECU, and transmitting the generated signals or data to the master transceiver 42m.

In S215, the first controller 41m determines whether the switch condition C7 is satisfied by determining whether the processing required to switch to the network mode A101 corresponding to the returning factor is completed.

The first controller 41m repeats the process in S215 until the switch condition C7 being determined to be satisfied in S215 (S215: NO).

In response to determining, in S215, that the switch condition C7 is satisfied (S215: YES), the first controller 41m proceeds to S220 and switches to the network mode A101.

In S225, the first controller 41m transmits a wake-up request destined to the second ECU 20, which corresponds to the adjacent ECU, to the master transceiver 42m. After transmitting the wake-up request, the first controller 41m ends the process shown in FIG. 5.

In response to receiving the wake-up request, the master transceiver 42m switches from the sleep state to the normal state and transmits the wake-up request to the second ECU 20, which corresponds to the adjacent ECU. Abbreviation of “WU” in FIG. 4 indicates transmission of wake-up request. The arrows associated with the abbreviation “WU” indicate transmission source and transmission destination of the wake-up request.

Similar to the first ECU 10, the second ECU 20 starts the process shown in FIG. 5 when the second controller 41s switches to the sleep mode A104.

First, the second controller 41s repeats the process of S200 until the switch condition C6 is determined to be satisfied in response to occurrence of the returning factor (S200: NO).

When the slave transceiver 42s of the second ECU 20 receives the wake-up request transmitted from the master transceiver 42m, the slave transceiver 42s executes processing to restart the predetermined function that was stopped by the sleep function, and switches from the sleep state to the normal state. In response to the slave transceiver 42s switching to the normal state, both of the master transceiver 42m and the slave transceiver 42s become to the normal states. That is, both of the first ECU 10 and the second ECU 20 are switched to the link-up states.

The slave transceiver 42s notifies the second controller 41s about reception of the wake-up request. The description “WU notification” in FIG. 4 indicates a notification about reception of wake-up request.

Upon receiving the notification about reception of wake-up request, the second controller 41s determines that the switch condition C6 is satisfied in S200 (S200: YES), and proceeds to S205. In S205, the second controller 41s switches to the bus sleep mode A103.

The processes in subsequent S210, S215, S220 executed by the second ECU 20 is the same as that executed in the first ECU 10. In S220, the second controller 41s switches to the network mode A101. In a case where the second ECU 20 includes a transceiver 42 other than the slave transceiver 42s, the second ECU 20 further performs S225, and then ends the process shown FIG. 5. In a case where the second ECU 20 does not include a transceiver 42 other than the slave transceiver 42s, the second ECU 20 does not perform S225 and ends the process shown in FIG. 5.

As described above, in response to occurrence of the returning factor, the first ECU 10 corresponding to the returning factor switches from the sleep mode A104 to the network mode A101, and then transmits the wake-up request to the second ECU 20, which corresponds to the adjacent ECU. Upon receiving the wake-up request from the first ECU 10, the second ECU 20 switches from the sleep mode A104 to the network mode A101.

In a case where the ignition switch is turned from off state to on state, the controller 41 switches to the bus sleep mode A103 and similarly performs the above-described process from S210. In this case, the switch condition C7 in S215 is to be read as the switch condition C1, that is the condition for performing processing required to start the operation in the network mode A101 is completed.

### (1-2-5-2. Switch From Normal Mode to Power-Saving Mode)

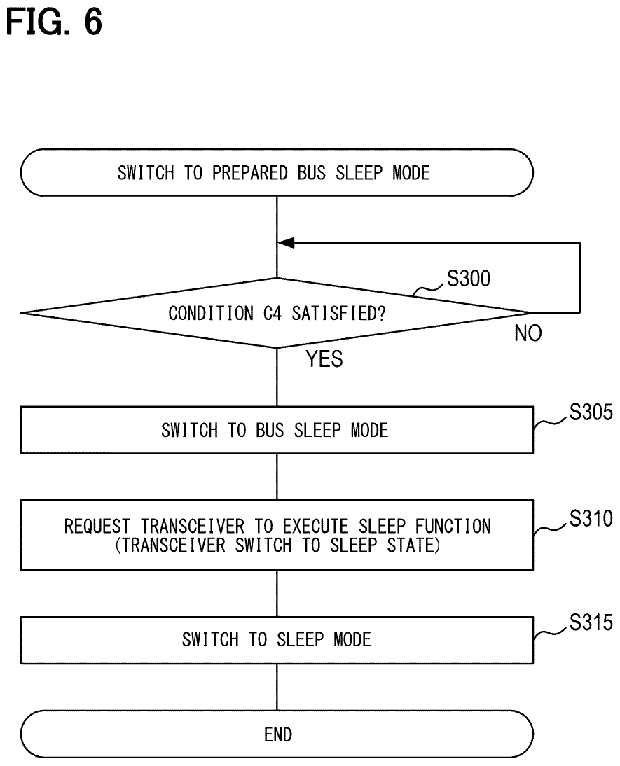

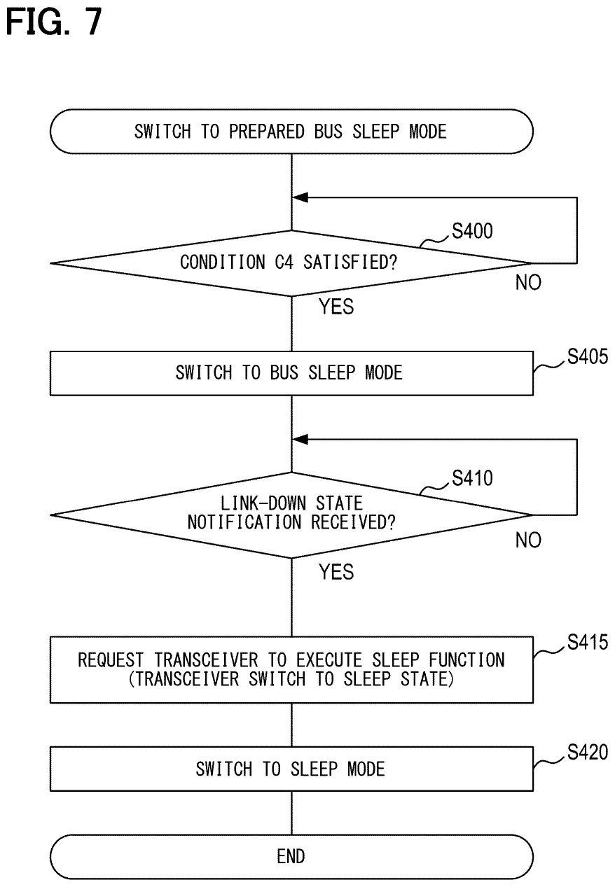

The operation mode of controller 41 and the state switch of the transceiver 42 of each ECU when switching from the normal mode to the power-saving mode will be described with reference to the flowcharts of FIG. 4, FIG. 6, and FIG. 7.

When the predetermined period has elapsed with no communication being occurred between local ECU operating in the normal mode and the adjacent ECU, thereby the switch condition being satisfied, each controller 41m, 41s of local ECU switches to the prepared bus sleep mode A102. At this time, the transceivers 42m and 42s of each ECU are in the normal states. That is, the first ECU 10 and the second ECU 20 are both in the link-up state.

The process executed by each ECU to switch from the normal mode to the power-saving mode differs depending on whether the transceiver 42 included in the ECU is the master transceiver 42m or the slave transceiver 42s.

When the first controller 41m of first ECU 10, which includes the master transceiver 42m, switches to the prepared bus sleep mode A102, the first controller 41m starts the process shown in FIG. 6.

The first controller 41m repeats the process in S300 until the switch condition C4 is determined to be satisfied (S300: NO). As described above, the switch condition C4 is satisfied when a predetermined period has elapsed in a state where a communication other than the specific communication is not occurred between local ECU and the adjacent ECU.

In a case where the first controller 41m determines in S300 that the switch condition C4 is satisfied (S300: YES), the process proceeds to S305, and the first controller 41m switches to the bus sleep mode A103.

In S310, the first controller 41m requests the master transceiver 42m to execute the sleep function. The master transceiver 42m switches from the normal state to the sleep state by executing the sleep function in response to the received request. The term “sleep request” shown in FIG. 4 indicates a request to execute the sleep function.

In S315, in response to confirming that the master transceiver 42m has been switched to the sleep state, the first controller 41m switches to the sleep mode A104 and ends the process shown in FIG. 6.

In response to the switch condition C4 being satisfied in the prepared bus sleep mode A102, the first controller 41m switches to the bus sleep mode A103. The first controller 41m requests the master transceiver 42m to execute the sleep function, and switches to the sleep mode A104 in response to the master transceiver 42m being switched to the sleep state.

When the second controller 41s of second ECU 20, which includes the slave transceiver 42s, switches to the prepared bus sleep mode A102, the second controller 41s starts the process shown in FIG. 7.

The second controller 41s repeats the process in S400 until the switch condition C4 is determined to be satisfied (S400: NO).

In a case where the second controller 41s determines in S400 that the switch condition C4 is satisfied (S400: YES), the process proceeds to S405, and the second controller 41s switches to the bus sleep mode A103.

The second controller 41s repeats the process in S410 until a link-down notification related to the first ECU 10 is received from the slave transceiver 42s (S410: NO). The term “link-down notification” shown in FIG. 4 indicates a link-down notification related to the first ECU 10 that is transmitted from the slave transceiver 42s to the second controller 41s when a link-down of the first ECU 10 is detected.

When the second controller 41s receives the link-down notification related to the first ECU 10 from the slave transceiver 42s in S410, the second controller 41s proceeds to S415 and requests the slave transceiver 42s to execute the sleep function. When the slave transceiver 42s receives the request to execute the sleep function, the slave transceiver 42s executes the sleep function and switches from the normal state to the sleep state. After receiving the notification in S410, the second controller 41s may immediately request the slave transceiver 42s to execute the sleep function, or may wait for a certain period of time before outputting the request.

In S420, in response to confirming that the slave transceiver 42s has been switched to the sleep state, the second controller 41s switches to the sleep mode A104 and ends the process shown in FIG. 7.

In the second ECU 20 including the slave transceiver 42s, in response to the switch condition C4 being satisfied in the prepared bus sleep mode A102, the second controller 41s switches to the bus sleep mode A103. Thereafter, the slave transceiver 42s waits until switch of the first ECU 10 to the link-down state is detected, and then the slave transceiver 42s switches to the sleep state and the second controller 41s switches to the sleep mode A104.

### 1-3. Technical Effects

According to the first embodiment described above, the following effects are obtained.

(1a) As shown in S310 of FIG. 6, after switching from the prepared bus sleep mode A102 to the bus sleep mode A103, the first controller 41 requests the master transceiver 42m to execute the sleep function. The master transceiver 42m switches from the normal state to the sleep state.

With this configuration, when the master transceiver 42m is requested to execute the sleep function, the master transceiver 42m can switch from the normal state to the sleep state without performing handshake. The handshake referred herein is a process in which the master transceiver 42m notifies the adjacent ECU that the master transceiver plans to switch to the sleep state and receives a response to the notification. Therefore, the master transceiver 42m can switch to the sleep state more quickly compared with a case where the handshake is performed. The handshake may fail due to delays or loss of communication during the process of handshake being executed. Therefore, according to the present embodiment in which the handshake is not required for switch to the sleep state, it is possible to suppress, for the master transceiver 42m, the obstruction in switch to the sleep state. The obstruction that obstructs the switch to sleep state is caused by a failure occurred in the handshake.

(1b) In some cases, the second controller 41s switches from the prepared bus sleep mode A102 to the bus sleep mode A103 before the master transceiver 42m switches to the sleep state. At this time, even though the slave transceiver 42s switches to the sleep state, there is a possibility that the slave transceiver 42s will return to the normal state due to reception of idle signal transmitted from the master transceiver 42m. In this case, the second ECU 20 switches to the power-saving mode with the slave transceiver 42s being remained in the normal state.

According to the first embodiment, as shown in S410 and S415 of FIG. 7, after the second controller 41s switches from the prepared bus sleep mode A102 to the bus sleep mode A103, the slave transceiver 42s waits until detecting that the first ECU 10 switches to the link-down state, and then switches to the sleep state.

In the above configuration, in a case where the master transceiver 42m is in the normal state that enables transmission of idle signal, the slave transceiver 42s remains in the normal state and does not switch to the sleep state. The slave transceiver 42s switches to the sleep state after the master transceiver 42m switches to the sleep state.

In the above configuration, after switching to the sleep state, the slave transceiver 42s will no longer receive the idle signal transmitted from the master transceiver 42m. Thus, the slave transceiver 42s can be prevented from switching from the sleep state to the normal state. Thus, the obstruction of mode switch to the sleep state in the slave transceiver 42s can be suppressed.

Similar to the master transceiver 42m, the slave transceiver 42s can switch from the normal state to the sleep state without performing the handshake.

Thus, the obstruction of mode switch to the sleep state in the slave transceiver 42s can be suppressed. The obstruction of mode switch to the sleep state is caused by the failure of handshake.

### 1-4. Correspondence Between Terms

In the above embodiment, the network mode A101 corresponds to an example of a first mode, the prepared bus sleep mode A102 corresponds to an example of a second mode, the bus sleep mode A103 corresponds to an example of a third mode, the link-up state corresponds to an example of a communication enabled state, the link-down state corresponds to an example of a communication disabled state, and the idle signal corresponds to an example of a detection signal.

### 2. Second Embodiment

### 2-1. Configuration

In the second embodiment, the basic configuration of control system 1 is similar to that of the first embodiment. In the following description, configurations of the control system 1 according to the second embodiment, which are different from those of the first embodiment, will be selectively described. In the second embodiment, configurations that are assigned the same reference symbols as in the first embodiment and are not described below may be understood to have the same or equivalent configurations as in the first embodiment.

### 2-2. Process

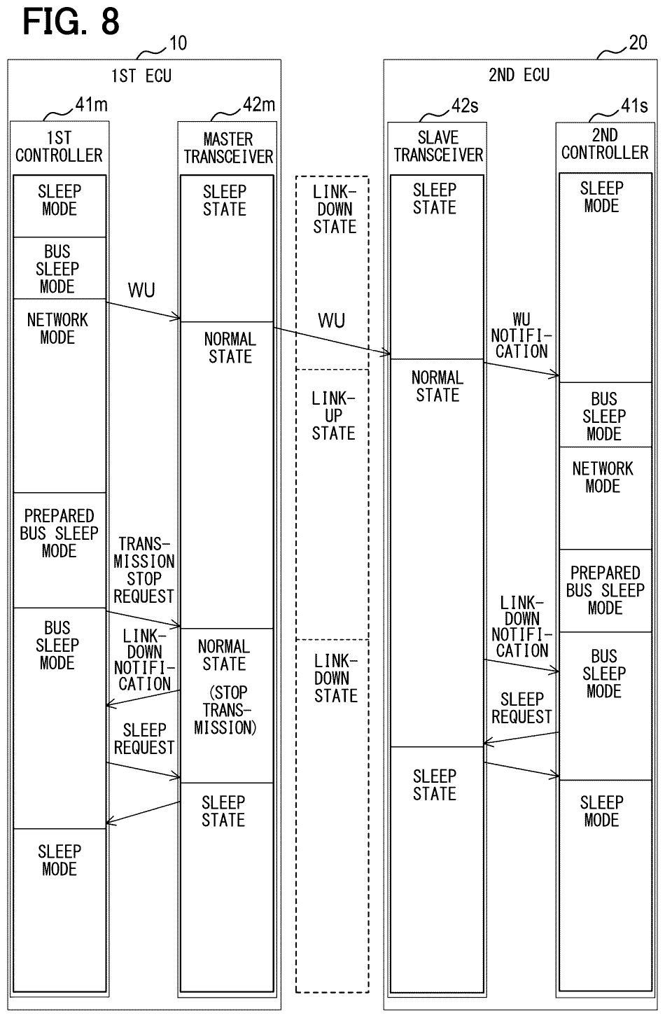

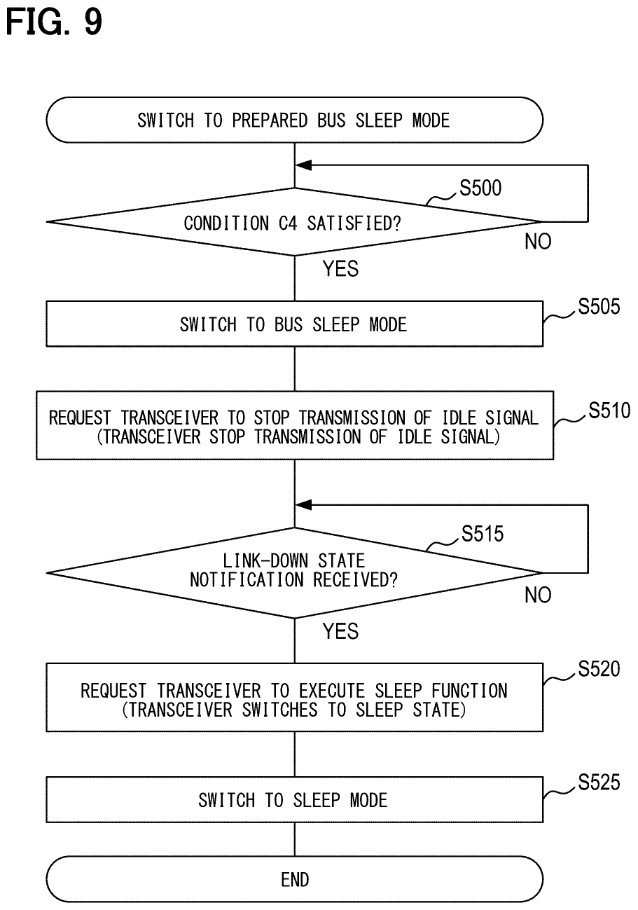

In the second embodiment, the operation mode of the first controller 41m of the first ECU 10 and the state switch of the master transceiver 42m in a case of switching from the normal mode to the power-saving mode will be described with reference to the flowcharts of FIG. 8 and FIG. 9.

The process executed in S500, S505, S520, and S525 in FIG. 9 are similar to the process executed in S300, S305, S310, and S315 in FIG. 6, respectively.

In the second embodiment, when the first controller 41m of first ECU 10 switches to the prepared bus sleep mode A102, the first controller 41m starts the process shown in FIG. 9.

The first controller 41m repeats the process in S500 until the switch condition C4 is determined to be satisfied (S500: NO).

In a case where the first controller 41m determines in S500 that the switch condition C4 is satisfied (S500: YES), the process proceeds to S505, and the first controller 41m switches to the bus sleep mode A103.

In S510, the first controller 41m requests the master transceiver 42m to stop transmission of the idle signal. When the master transceiver 42m receives the request to stop transmission of idle signal, the master transceiver 42m stops transmission of the idle signal to the slave transceiver 42s. As a result, the idle signal is no longer transmitted to the slave transceiver 42s, and the slave transceiver 42s also stops transmission of a response signal. Therefore, both the first ECU 10 and the second ECU 20 are in the link-down state. The term “transmission stop request” in FIG. 8 indicates a request to stop transmission of the idle signal. The first controller 41m may request the master transceiver 42m to stop transmission of other signals, data, or the like, in addition to the transmission of idle signal.

The first controller 41m repeats the process in S515 until a link-down notification related to the second ECU 20 is received from the master transceiver 42m (S515: NO). The term “link-down notification” in FIG. 8 indicates a link-down notification related to the second ECU 20 that is transmitted from the master transceiver 42m to the first controller 41m when a link-down state of the second ECU 20 is detected.

In S515, when the first controller 41m receives the link-down notification, which is related to the second ECU 20, from the master transceiver 42m (S515: YES), the first controller 41m proceeds to S520 and requests the master transceiver 42m to execute the sleep function. The term “sleep request” in FIG. 8 indicates a request to execute the sleep function. When the master transceiver 42m receives the request, the master transceiver 42m executes the sleep function to switch from the normal state to the sleep state. After receiving the link-down notification in S515, the first controller 41m may immediately request the master transceiver 42m to execute the sleep function, or may wait for a certain period of time before outputting the request.

In S525, under a condition that master transceiver 42m is confirmed to be in the sleep state, the first controller 41m switches to the sleep mode A104 and ends the process shown in FIG. 9.

As described above, in the second embodiment, when the first controller 41m switches from the prepared bus sleep mode A102 to the bus sleep mode A103, the first controller 41m stops the transmission of idle signal by the master transceiver 42m. Then, the first controller 41m requests the master transceiver 42m to execute the sleep function, and switches to the sleep mode A104 on condition that the master transceiver 42m switches to the sleep state in response to the request transmitted from the first controller.

When the master transceiver 42m switches from the sleep state to the normal state, the master transceiver 42m restarts the transmission of idle signal that was stopped in S510.

The first controller 41m does not need to perform the process of S515. In this case, the first controller 41m can request the master transceiver 42m to stop transmission of the idle signal in S510, and then proceed to S520 to request the master transceiver 42m to execute the sleep function.

### 2-3. Technical Effects

According to the second embodiment described above in detail, the same effects as those of the first embodiment can be obtained. In the second embodiment, when the first controller 41m switches from the prepared bus sleep mode A102 to the bus sleep mode A103, the first controller 41m stops the transmission of idle signal by the master transceiver 42m. Thus, the obstruction of state switch to the sleep state in the slave transceiver 42s can be suppressed. In the slave transceiver 42s, the obstruction of state switch to the sleep state is caused by reception of the idle signal, which is transmitted from the master transceiver 42m.

### 3. Third Embodiment

### 3-1. Configuration

In the third embodiment, the basic configuration of control system 1 is similar to that of the second embodiment. In the following description, configurations of the control system 1 according to the third embodiment, which are different from those of the second embodiment, will be selectively described. In the third embodiment, configurations that are assigned the same reference symbols as in the second embodiment and are not described below may be understood to have the same or equivalent configurations as in the second embodiment.

### 3-2. Process

### (3-2-1. Sleep Handshake State)

The transceiver 42 in the third embodiment switches between two of multiple states including a normal state, a sleep state, and a sleep handshake state. The transceiver 42 switches between two states out of the normal state, the sleep state, and the sleep handshake state, in accordance with a predetermined protocol. An example of a predetermined protocol is TC10 defined by the non-profit organization OPEN Alliance.

The sleep handshake state is a via state when switching from the normal state to the sleep state. In the sleep handshake state, the transceiver 42 performs the handshake as follows. The handshake is a process of notifying the adjacent ECU of a switch to the sleep state and receiving a response to the notification. After completing the handshake, the transceiver 42 stops the predetermined function of the transceiver 42, and switches to the sleep state. In a case where the handshake has not completed within the predetermined period of time (for example, within 16 milliseconds), the transceiver 42 considers that the handshake has failed and switches to the normal state.

The sleep function in the third embodiment is a function for the transceiver 42 to switch from the normal state to the sleep state via the sleep handshake state in response to a request from the controller 41.

The sleep function in the third embodiment includes, as a process related to handshake, notifying adjacent ECU of a switch to the sleep state. When the transceiver 42 executes the sleep function, the transceiver 42 transmits a signal (hereinafter referred to as a sleep signal) to an adjacent ECU informing execution of the sleep function. Under a condition that a signal (hereinafter referred to as a sleep response) in response to the sleep signal is received from the adjacent ECU, the transceiver stops the predetermined function of itself. The transceiver 42 notifies the switch to the sleep state by transmitting the sleep signal.

In the third embodiment, the sleep function is also executed in a case where the transceiver 42 receives the sleep signal from the adjacent ECU. In this case, the transceiver 42 notifies the controller 41 of local ECU of having received the sleep signal, transmits the response to the sleep signal to the adjacent ECU, and then stops the predetermined function of itself.

In a case where the transceiver 42 transmits or receives the sleep signal, the transceiver 42 switches from the normal state to the sleep handshake state. Then, the transceiver 42 receives or transmits the sleep response, and performs processing to stop the predetermined function of the transceiver 42. After completing the process, the transceiver 42 switches from the sleep handshake state to the sleep state.

### (3-2-2. Switch From Normal Mode to Power-Saving Mode)

The operation mode of controller 41 and the state switch of the transceiver 42 of each ECU in a case of switching from the normal mode to the power-saving mode according to the third embodiment will be described.

### (3-2-2-1. Handshake Initiated by Slave Transceiver)

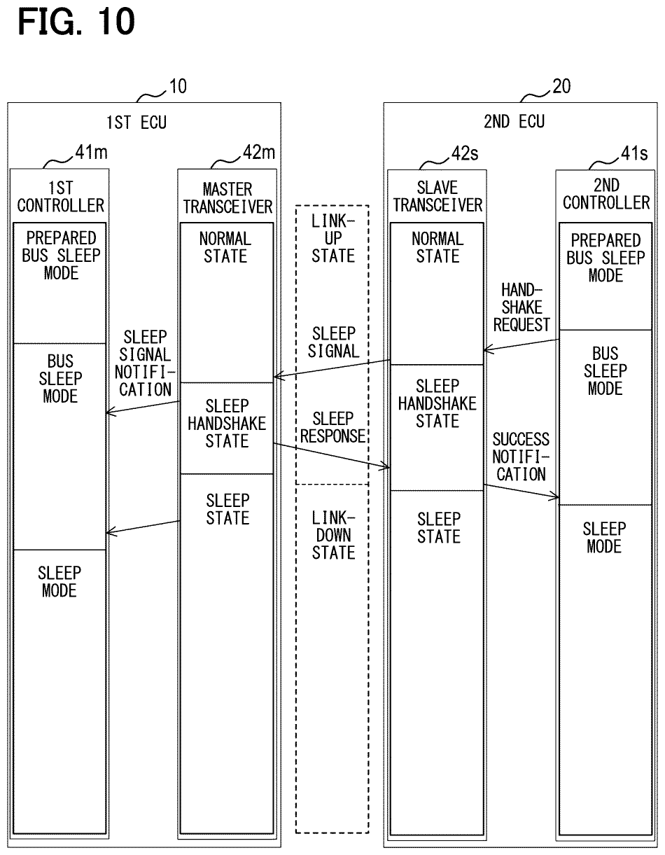

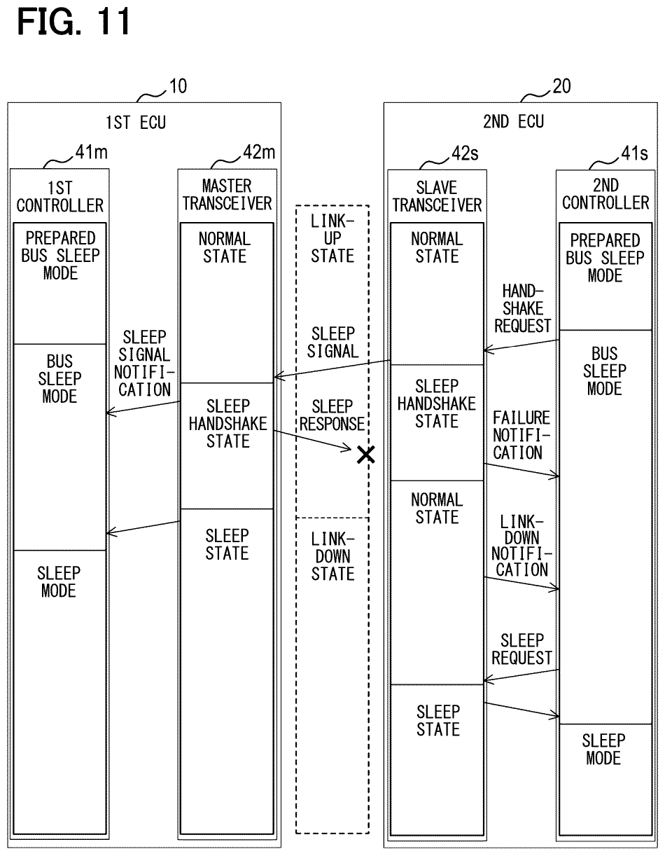

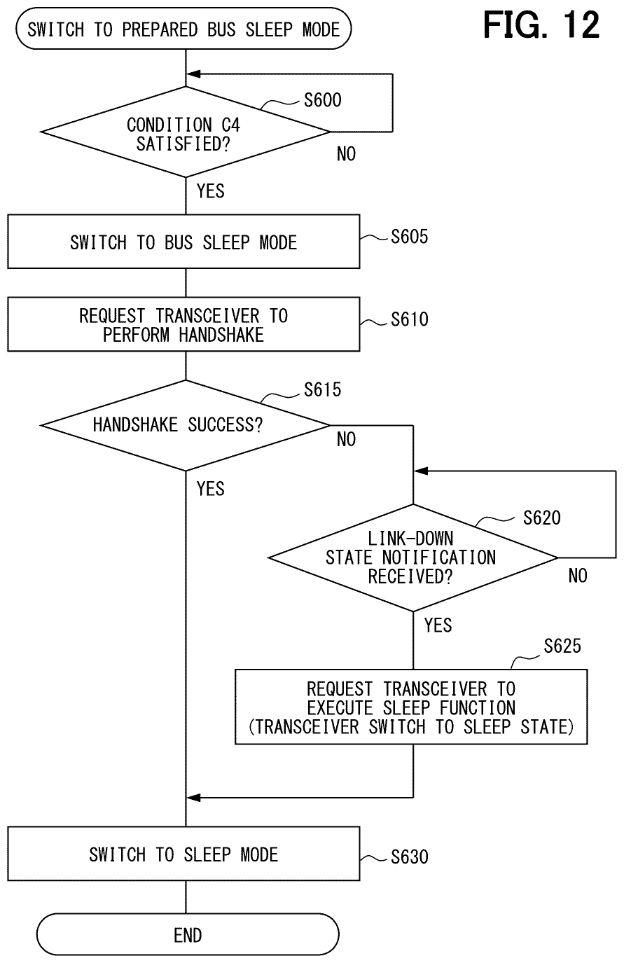

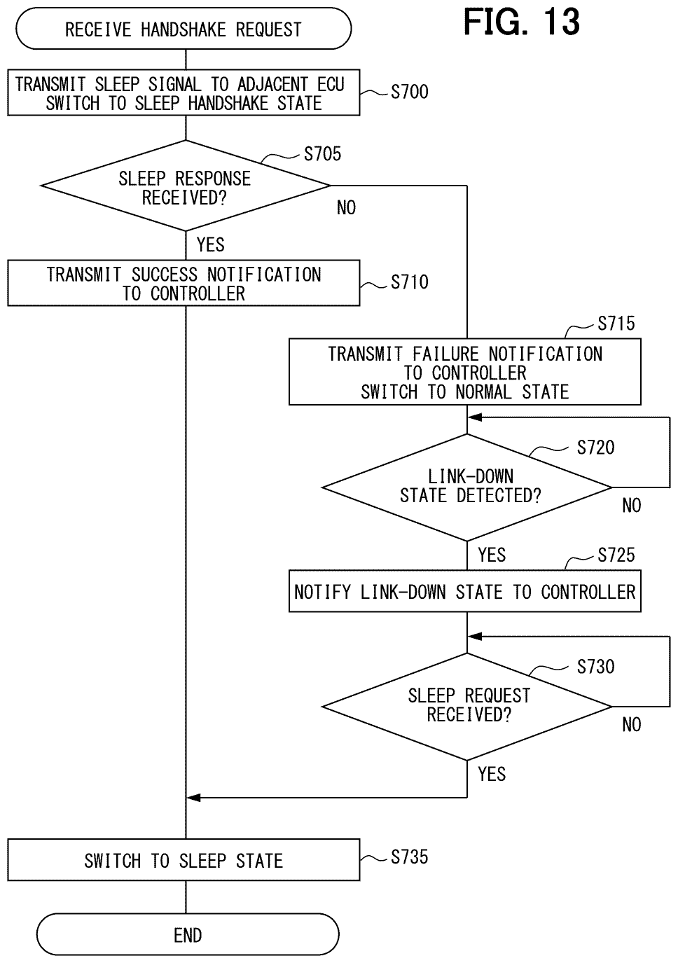

The process in which the second ECU 20 starts a handshake with the first ECU 10 and each ECU switches from the normal mode to the power-saving mode will be described with reference to the flowcharts of FIG. 10, FIG. 11, FIG. 12, and FIG. 13.

The process executed in S600, S605, S620, S625, and S630 in FIG. 12 are similar to the process executed in S400, S405, S410, S415, and S420 in FIG. 7 (that is, the processes according to the first embodiment), respectively.

In the third embodiment, when the second controller 41s of the second ECU 20 switches to the prepared bus sleep mode A102, the second controller 41s starts the process shown in FIG. 12.

The second controller 41s repeats the process in S600 until the switch condition C4 is determined to be satisfied (S600: NO).

In a case where the second controller 41s determines in S600 that the switch condition C4 is satisfied (S600: YES), the process proceeds to S605, and the second controller 41s switches to the bus sleep mode A103.

In S610, the second controller 41s requests the slave transceiver 42s to execute the sleep function, which includes the handshake. Hereinafter, the request transmitted in S610 is also referred to as a handshake request. The term “handshake request” in FIG. 10 and FIG. 11 indicates transmission of the handshake request.

Upon receiving the handshake request from the second controller 41s, the slave transceiver 42s starts the process shown in FIG. 13.

In S700, the slave transceiver 42s transmits the sleep signal to the first ECU 10, which corresponds to the adjacent ECU, and switches to the sleep handshake state. The term “sleep signal” in FIG. 10 and FIG. 11 indicates transmission of the sleep signal.

The master transceiver 42m of the first ECU 10, which has received the sleep signal from the second ECU 20, switches to the sleep handshake state. The master transceiver 42m further notifies the first controller 41m about reception of the sleep signal, and replies a sleep response to the slave transceiver 42s. The term “sleep signal notification” in FIG. 10 and FIG. 11 indicates a notification about reception of the sleep signal from the adjacent ECU. The term “sleep response” in FIG. 10 and FIG. 11 indicates transmission of the sleep response. Thereafter, the master transceiver 42m switches to the sleep state. At this time, when the first controller 41m, which is operating in the bus sleep mode A103, can confirm that the master transceiver 42m is in the sleep state, the first controller 41m switches to the sleep mode A104.

In S705, the slave transceiver 42s determines whether a sleep response is received within a predetermined period of time (for example, within 16 milliseconds).

In a case where the slave transceiver 42s determines, in S705, that the sleep response is received within the predetermined period (S705: YES), the slave transceiver 42s proceeds to S710 and notifies the second controller 41s about reception of the sleep response. The term “success notification” in FIG. 10 indicates a notification about reception of the sleep response by the slave transceiver 42s within the predetermined period. The “success notification” indicates that the handshake is successful.

In S735, the slave transceiver 42s switches from the sleep handshake state to the sleep state, and the process shown in FIG. 13 is ended.

In a case where the slave transceiver 42s determines, in S705, no reception of sleep response within the predetermined period (S705: NO), the slave transceiver 42s proceeds to S715. In S715, the slave transceiver notifies the second controller 41s about no reception of the sleep response, and switches to the normal state. The term “failure notification” in FIG. 11 indicates a notification about no reception of the sleep response by the slave transceiver 42s within the predetermined period. The “failure notification” indicates that the handshake is failed. Examples of cases in which the handshake fails include in a case where the sleep signal or sleep response is lost due to a network malfunction, or in a case where the first ECU 10 is not operating normally and is unable to reply the sleep response.

In a case where the slave transceiver 42s fails to receive the sleep response within the predetermined period in S705, the slave transceiver 42s may perform a retransmission process to transmit the sleep signal to the first ECU 10 again. The retransmission process may be repeated by a predetermined number of times. In a case where the retransmission process is executed by the predetermined number of times, in response to the slave transceiver 42s receiving the sleep response one or more times out of the predetermined number of times by which the retransmission process is repeated, the slave transceiver may determine in S705 that the sleep response is received within the predetermined period. In a case where the retransmission process is executed by the predetermined number of times, in response to the slave transceiver 42s failing to receive the sleep response even once within the predetermined number of times by which the retransmission process is repeated, the slave transceiver may determine in S705 that the sleep response is not received within the predetermined period.

In S720, the slave transceiver 42s determines whether the link-down state of the first ECU 10 is detected. The slave transceiver 42s detects that the first ECU 10 is in the link-down state when an idle signal from the first ECU 10 is not received for a predetermined period of time (for example, several seconds). The slave transceiver 42s repeats the process in S720 until the slave transceiver 42s determines that the link-down state of first ECU 10 is detected (S720: NO).

In a case where the slave transceiver 42s determines, in S720, that the link-down state of first ECU 10 is detected (S720: YES), the slave transceiver 42s proceeds to S725 and notifies the second controller 41s that the link-down state of the first ECU 10 is detected. The term “link-down notification” in FIG. 11 indicates a notification transmitted from the slave transceiver 42s to the second controller 41s for notifying detection of the first ECU 10 being in the link-down state.

The slave transceiver 42s repeats the process in S730 until reception of a sleep request from the second controller 41s (S730: NO).

In a case where the slave transceiver 42s determines, in S730, that the sleep request transmitted from the second controller 41s is received (S730: YES), the process proceeds to S735. In S735, the slave transceiver 42s switches to the sleep state and ends the process shown in FIG. 13.

As described above, when the slave transceiver 42s switches from the normal state to the sleep state, the slave transceiver 42s performs the handshake with the first ECU 10, which corresponds to the adjacent ECU, and switches to the sleep handshake state. In a case where the handshake is succeeded, the slave transceiver 42s switches from the sleep handshake state to the sleep state. In a case where the handshake is failed, the slave transceiver 42s waits until switch of the first ECU 10 to the link-down state is detected, and then switches to the sleep state.

Returning to FIG. 12, in S615, the second controller 41s determines whether the handshake is succeeded or failed. That is, by receiving the notification of S710 or S715 from the slave transceiver 42s, the second controller 41s determines whether the slave transceiver 42s has received the sleep response within the predetermined period of time.

In a case where the second controller 41s determines in S615 that the handshake is succeeded (S615: YES), the process proceeds to S630. In S630, the second controller 41s switches to the sleep mode A104 and ends the process shown in FIG. 12.

In a case where the second controller 41s determines that the handshake has failed in S615 (S615: NO), the second controller 41s repeats the process of S620 until reception of the link-down notification, which is related to the first ECU 10, from the slave transceiver 42s (S620: NO). The term “link-down notification” in FIG. 11 indicates the link-down notification, which is related to the first ECU 10 and is transmitted from the slave transceiver 42s to the second controller 41s.

In S620, when the second controller 41s receives the link-down notification related to the first ECU 10 from the slave transceiver 42s (S620: YES), the second controller 41s proceeds to S625. In S625, the second controller 41s requests the slave transceiver 42s to execute the sleep function. The term “sleep request” in FIG. 11 indicates a request to execute the sleep function. The slave transceiver 42s executes the sleep function in response to the request, thereby switching from the normal state to the sleep state (S730, S735 in FIG. 13). After receiving the notification in S620, the second controller 41s may immediately request the slave transceiver 42s to execute the sleep function, or may wait for a certain period of time before outputting the request.

In S630, in response to confirming that the slave transceiver 42s has been switched to the sleep state, the second controller 41s switches to the sleep mode A104 and ends the process shown in FIG. 12.

As described above, the second ECU 20 first attempts the handshake in order to switch to the power-saving mode. In a case where the handshake is succeeded, the second ECU 20 switches from the normal mode to the power-saving mode. In a case where the handshake is failed, the second ECU 20 performs the same process as in the first embodiment to switch from the normal mode to the power-saving mode.

### (3-2-2-2. Handshake Initiated by Master Transceiver)

The above describes the process in which the second ECU 20 initiates the handshake with the first ECU 10 and each ECU switches from the normal mode to the power-saving mode. The process in which the first ECU 10 initiates the handshake with the second ECU 20 and each ECU switches from the normal mode to the power-saving mode is similar as the case where the second ECU 20 initiates the handshake with the first ECU 10 and each ECU switches from the normal mode to the power-saving mode.

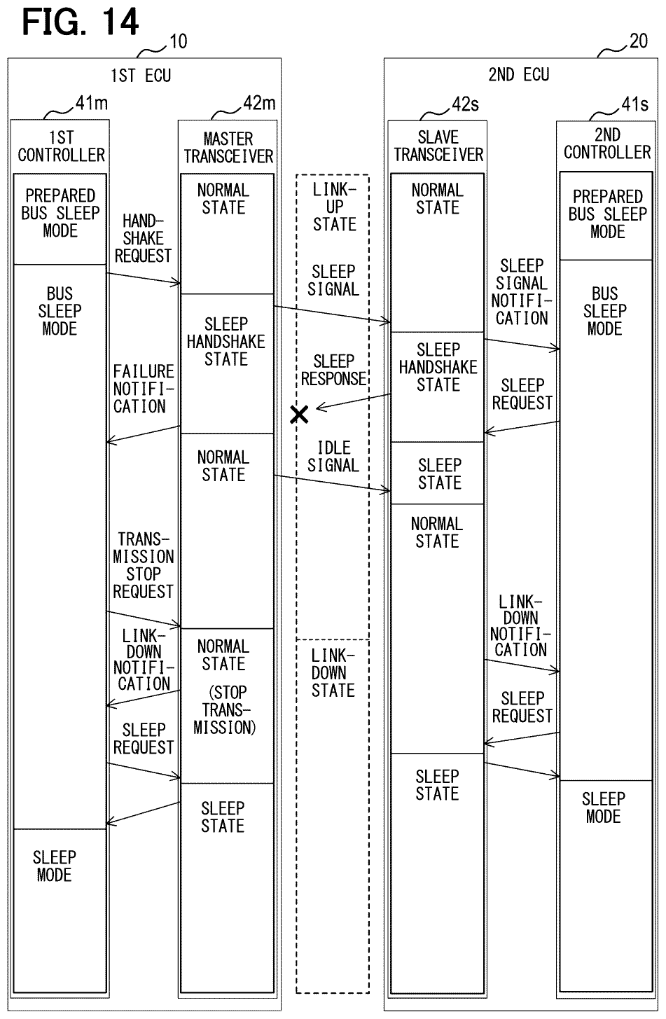

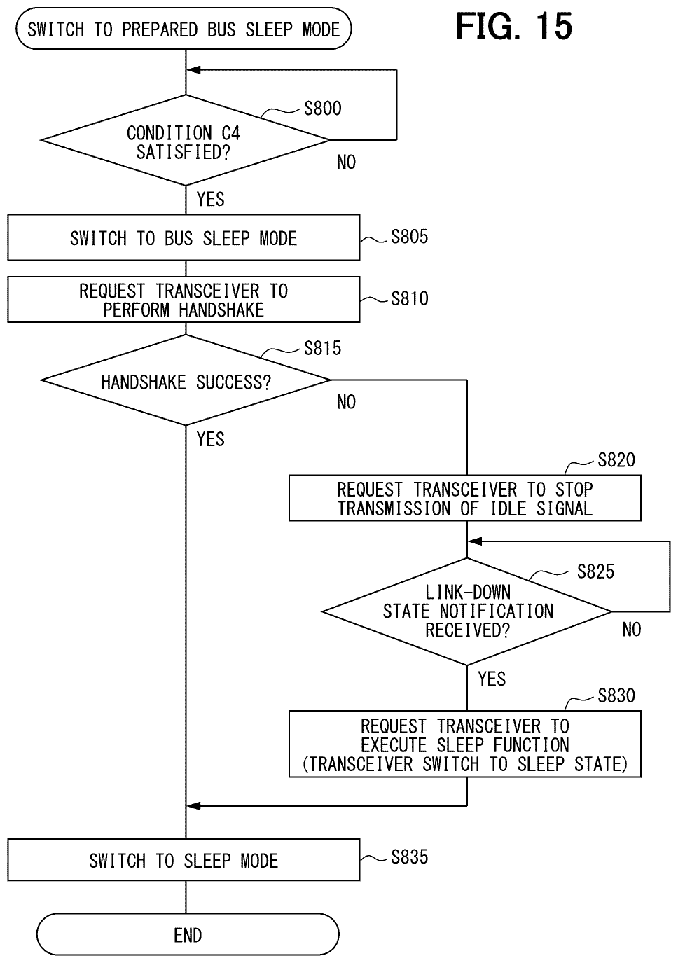

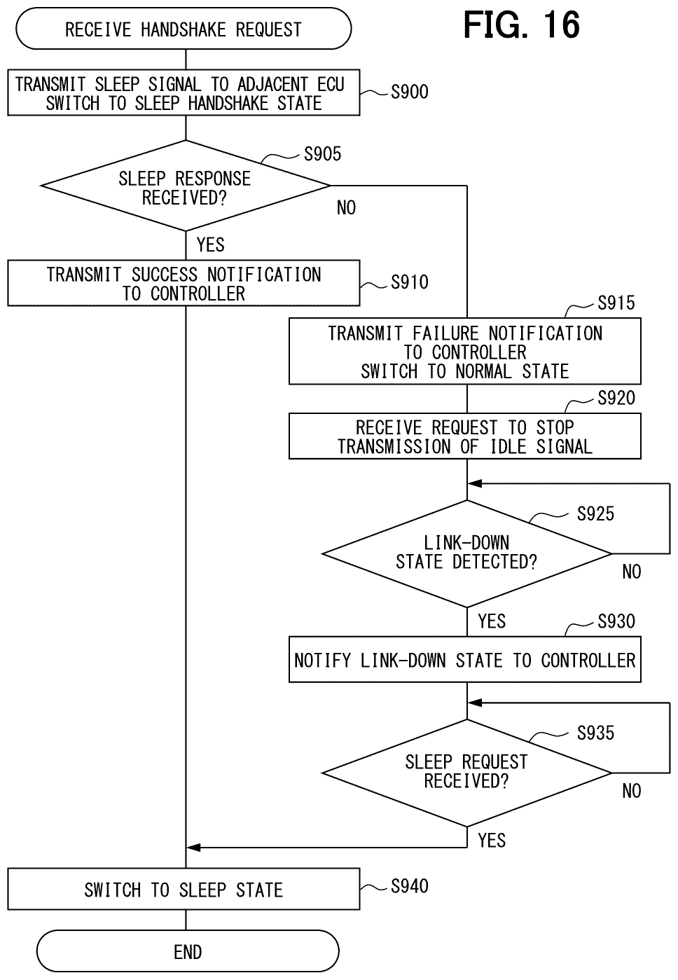

The process in which the first ECU 20 starts the handshake with the second ECU 20 and each ECU switches from the normal mode to the power-saving mode will be described with reference to the flowcharts of FIG. 14, FIG. 15, and FIG. 16.

In the third embodiment, when the second controller 41s of the second ECU 20 switches to the prepared bus sleep mode A102, the second controller 41s starts the process shown in FIG. 15.

The process executed in S800, S805, S820, S825, S830, and S835 in FIG. 15 are similar to the process executed in S500, S505, S510, S515, S520, and S525 in FIG. 9 (that is, the processes in the second embodiment), respectively.

The first controller 41m repeats the process in S800 until the switch condition C4 is determined to be satisfied (S800: NO).

In a case where the first controller 41m determines in S800 that the switch condition C4 is satisfied (S800: YES), the process proceeds to S805, and the first controller 41m switches to the bus sleep mode A103.

In S810, the first controller 41m transmits a handshake request to the master transceiver 42m. The term “handshake request” in FIG. 14 indicates transmission of a handshake request.

When the master transceiver 42m receives the handshake request from the first controller 41m, the master transceiver 42m starts the process shown in FIG. 16.

The process executed in of S900, S905, S910, S915, S925, S930, S935, and S940 in FIG. 16 are similar to the process executed in S700, S705, S710, S715, S720, S725, S730, and S735 in FIG. 13, respectively.

In S900, the master transceiver 42m transmits a sleep signal to the second ECU 20, which corresponds to the adjacent ECU, and switches to the sleep handshake state. The term “sleep signal” in FIG. 14 indicates transmission of a sleep signal.

The slave transceiver 42s of the second ECU 20, which has received the sleep signal from the first ECU 10, switches to the sleep handshake state. The slave transceiver 42s further notifies the second controller 41s about reception of the sleep signal, and replies a sleep response to the master transceiver 42m. The term “sleep signal notification” in FIG. 14 indicates a notification about reception of sleep signal from the adjacent ECU. The term “sleep response” in FIG. 14 indicates transmission of the sleep response. Thereafter, the slave transceiver 42s switches to the sleep state.

In S905, the master transceiver 42m determines whether a sleep response is received within a predetermined period of time (for example, within 16 milliseconds).

In a case where the master transceiver 42m determines, in S905, that the sleep response is received within the predetermined period (S905: YES), the master transceiver 42m proceeds to S910 and notifies the first controller 41m about reception of the sleep response.

In S940, the master transceiver 42m switches from the sleep handshake state to the sleep state, and the process shown in FIG. 16 is ended.

In a case where the master transceiver 42m determines, in S905, no reception of sleep response within the predetermined period (S905: NO), the master transceiver 42m proceeds to S915. In S915, the master transceiver notifies the first controller 41m about no reception of the sleep response, and switches to the normal state. The term “failure notification” in FIG. 14 indicates a notification about no reception of the sleep response by the master transceiver 42m within the predetermined period. The “failure notification” indicates that the handshake is failed.

When the master transceiver 42m switches to the normal state, the master transceiver restarts transmission of the idle signal. Therefore, the slave transceiver 42s returns from the sleep state to the normal state due to the reception of idle signal.

In a case where the master transceiver 42m fails to receive the sleep response within the predetermined period in S905, the master transceiver 42m may perform a retransmission process to transmit the sleep signal to the second ECU 20 again. The retransmission process may be repeated by a predetermined number of times. In a case where the retransmission process is executed by the predetermined number of times, in response to the master transceiver 42m receiving the sleep response one or more times out of the predetermined number of times by which the retransmission process is repeated, the master transceiver may determine in S905 that the sleep response is received within the predetermined period. In a case where the retransmission process is executed by the predetermined number of times, in response to the master transceiver 42m failing to receive the sleep response even once within the predetermined number of times by which the retransmission process is repeated, the master transceiver may determine in S905 that the sleep response is not received within the predetermined period.

Returning to FIG. 15, in S815, the first controller 41m determines whether the handshake is succeeded or failed. That is, by receiving the notification of S910 or S915 from the master transceiver 42m, the first controller 41m determines whether the master transceiver 42m has received the sleep response within the predetermined period of time.

In a case where the first controller 41m determines in S815 that the handshake is succeeded (S815: YES), the process proceeds to S835. In S835, the first controller 41m switches to the sleep mode A104 and ends the process shown in FIG. 15.

In a case where the first controller 41m determines in S815 that the handshake is failed (S815: NO), the process proceeds to S820. In S820, the first controller 41m requests the master transceiver 42m to stop transmission of the idle signal.

The process executed in S825, S830, and S835 by the first controller 41m is similar to the process executed in of S515, S520, and S525 in FIG. 9, respectively, and detailed description thereof will be omitted.

Returning to FIG. 16, in S920, in response to receiving a request to stop transmission of the idle signal from the first controller 41m, the master transceiver 42m stops transmission of the idle signal.

The process executed in S925, S930, S935, and S940 by the master transceiver 42m are similar to the process executed in S720, S725, S730, and S735 in FIG. 13, respectively, and detailed description thereof will be omitted. In the process executed in S925, S930, S935, and S940, and the process executed in S720, S725, S730, and S735, the first ECU 10 and the second ECU 20 are replaced with one another, the first controller 41m and the second controller 41s are replaced with one another, and the master transceiver 42m and the slave transceiver 42s are replaced with one another.

As described above, the first ECU 10 first attempts the handshake in order to switch to the power-saving mode. In a case where the handshake is successful, the first ECU 10 switches from the normal mode to the power-saving mode. In a case where the handshake fails, the first ECU 10 performs the same process as in the second embodiment to switch from the normal mode to the power-saving mode.

### 3-3. Technical Effects

According to the third embodiment, the same effects as those of the first and second embodiments can be obtained. In addition, according to the third embodiment, the handshake is carried out under the standard (for example, TC10) that requires a handshake In a case of switching to the power-saving mode, it is possible to switch to the power-saving mode even if the handshake is failed.

### 4. Other Embodiments

Although the embodiments of the present disclosure have been described above, the present disclosure is not limited to the above embodiments and can be modified as necessary.

(4a) In the above embodiments, the control system 1 includes two ECUs, that is, the first ECU 10 and the second ECU 20. The number of ECUs included in the control system 1 is not limited to two and may be three or more.

(4b) In the above embodiment, each ECU in the control system 1 includes one controller 41 and one transceiver 42. Alternatively, each ECU may have at least one controller 41 and at least one transceiver 42, for example, may have two or more controllers and two or more transceivers.

The ECUs included in the control system 1 may include an ECU, which does not include a controller 41 but includes multiple transceivers 42. This type of ECU operates as a switch. The ECU may be a relay device having a function of transferring data received from another ECU connected to the local ECU. For example, the ECU may be a gateway device or an Ethernet switch.

(4c) Multiple functions of one configuration element in the above embodiments may be implemented by multiple configuration elements, or a single function of one configuration element may be implemented by multiple configuration elements. A part of the configuration of the above embodiments may be omitted as appropriate. At least a part of the configuration in one embodiment may be added to or substituted for the configuration of another embodiment.

(4d) The present disclosure can be implemented in various embodiments in addition to the ECU and the control system described in the above embodiments. For example, the present disclosure can be implemented as a control system that includes the ECU as a component, a computer program for causing a computer to function as the ECU, a non-transitory tangible storage medium such as a semiconductor memory in which the computer program is stored, a control method, and the like.

What is claimed is:

1. An electronic control device, which is mounted on a vehicle, comprising:
at least one transceiver configured to perform a communication with a communication device; and
a controller configured to switch between two of multiple modes including a first mode, a second mode, and a third mode, thereby operating in one of the multiple modes,
wherein
the controller:
operates in the first mode to perform a process associated with the communication in a case where the communication is being performed with the communication device by the at least one transceiver;
switches to the second mode in a case where no communication is performed in the first mode;
switches to the third mode in a case where a state in which no communication is performed in the second mode continues for a predetermined period of time; and
stops at least a part of the process associated with the communication in the third mode, and
the at least one transceiver:
switches between two of multiple states including a normal state in which a predetermined function of the at least one transceiver is in an operation state and a sleep state in which the predetermined function of the at least one transceiver is in a stopped state, thereby operating in one of the multiple states; and
switches to the sleep state in a case where the at least one transceiver detects a communication disabled state, in which the communication with the communication device is disabled, in a state where the controller is operating in the third mode.

2. The electronic control device according to claim 1, wherein
the at least one transceiver:
transmits a sleep signal to the communication device to notify the communication device that the at least one transceiver is going to switch to the sleep state in a case where the controller is operating in the third mode;
switches to the sleep state in a case where a response to the sleep signal is received from the communication device; and
detects that the communication device is in the communication disabled state and then switches to the sleep state in a case where the response to the sleep signal is not received for a predetermined period of time from the communication device.

3. An electronic control device, which is mounted on a vehicle, comprising:
at least one transceiver configured to perform a communication with a communication device; and
a controller configured to switch between two of multiple modes including a first mode, a second mode, and a third mode, thereby operating in one of the multiple modes,
wherein
the controller:
operates in the first mode to perform a process associated with the communication in a case where the communication is being performed with the communication device by the at least one transceiver;
switches to the second mode in a case where no communication is performed in the first mode;
switches to the third mode in a case where a state in which no communication is performed in the second mode continues for a predetermined period of time; and
stops at least a part of the process associated with the communication in the third mode, and
the at least one transceiver:
switches between two of multiple states including a normal state in which a predetermined function of the at least one transceiver is in an operation state and a sleep state in which the predetermined function of the at least one transceiver is in a stopped state, thereby operating in one of the multiple states;
repeatedly transmits, in the normal state, a detection signal to the communication device for detecting whether the communication device is in a communication disabled state in which the communication is disabled; and
stops transmission of the detection signal and then switches to the sleep state in a case where the controller is operating in the third mode.

4. The electronic control device according to claim 3, wherein
the at least one transceiver:
transmits a sleep signal to the communication device to notify the communication device that the at least one transceiver is going to switch to the sleep state in a case where the controller is operating in the third mode;
switches to the sleep state in a case where a response to the sleep signal is received from the communication device; and
stops transmission of the detection signal and then switches to the sleep state in a case where the response to the sleep signal is not received for a predetermined period of time from the communication device.

5. A control system comprising a plurality of the electronic control devices according to claim 1, wherein
the plurality of the electronic control devices are configured to function as nodes of an in-vehicle network of the vehicle,
each of the plurality of the electronic control devices is configured to communicate with an adjacent one of the plurality of the electronic control devices within the in-vehicle network, and
the adjacent one of the plurality of the electronic control devices corresponds to the communication device.

6. A computer-implemented method of controlling an electronic control device, the electronic control device including a controller and at least one transceiver configured to perform a communication with a communication device, the method comprising:
switching the controller between two of multiple modes including a first mode, a second mode, and a third mode, thereby operating the controller in one of the multiple modes; and
switching the at least one transceiver between two of multiple states including a normal state in which a predetermined function of the at least one transceiver is in an operation state and a sleep state in which the predetermined function of the at least one transceiver is in a stopped state, thereby operating the at least one transceiver in one of the multiple states,
wherein
the controller operating in one of the multiple modes includes:
operating in the first mode to perform a process associated with the communication in a case where the communication is being performed with the communication device by the at least one transceiver;
switching to the second mode in a case where no communication is performed in the first mode;
switching to the third mode in a case where a state in which no communication is performed in the second mode continues for a predetermined period of time; and
stopping at least a part of the process associated with the communication in the third mode, and
the at least one transceiver operating in one of the multiple states includes switching to the sleep state in a case where the at least one transceiver detects a communication disabled state, in which the communication with the communication device is disabled, in a state where the controller is operating in the third mode.

7. A computer program product stored in a computer-readable non-transitory storage medium, the computer program product comprising instructions for controlling a computer included in an electronic control device to execute a process, the electronic control device further including at least one transceiver configured to perform a communication with a communication device, the at least one transceiver switching between two of multiple states including a normal state in which a predetermined function of the at least one transceiver is in an operation state and a sleep state in which the predetermined function of the at least one transceiver is in a stopped state, thereby operating in one of the multiple states,
the instructions comprising:
switching between two of multiple modes including a first mode, a second mode, and a third mode, thereby operating in one of the multiple modes, wherein the operating in one of the multiple modes includes
operating in the first mode to perform a process associated with the communication in a case where the communication is being performed with the communication device by the at least one transceiver,
switching to the second mode in a case where no communication is performed in the first mode, and
switching to the third mode in a case where a state in which no communication is performed in the second mode continues for a predetermined period of time; and
stopping at least a part of the process associated with the communication and requesting the at least one transceiver to switch to the sleep state in a case where a communication disabled state, in which the communication with the communication device is disabled, is detected by the at least one transceiver in the third mode.
